(19) United States
(12) Patent Application Publication
(10) Pub. No.: US 2026/0220962 A1
(43) Pub. Date: Jul. 30, 2026

(54) AUTOMATIC PROCESSING AND EXTRACTING OF GRAPHICAL DATA

(71) Applicants: Kansas State University Research Foundation, Manhattan, KS (US); The Regents of the University of California, Oakland, CA (US)

(72) Inventors: Majid Jaberi-Douraki, Olathe, KS (US); Lisa A. Tell, Davis, CA (US)

(21) Appl. No.: 19/142,507

(22) PCT Filed: Dec. 21, 2023
(86) PCT No.: PCT/US2023/085517

§ 371 Date: Jun. 23, 2025

Related U.S. Application Data
(60) Provisional application No. 63/476,679, filed on Dec. 22, 2022.

(51) Int. Cl. G06V 30/422; G06V 10/26; G06V 10/82; G06V 30/148; G06V 30/19; G06V 30/413; G06V 30/414

(52) U.S. Cl. CPC G06V 30/422; G06V 10/26; G06V 10/82; G06V 30/148; G06V 30/19; G06V 30/413; G06V 30/414

(57) ABSTRACT

Computer implemented method for extracting numerical data from a graphical representation. The method includes: identifying a plurality of numerical character strings; assigning a plot location respectively to each of the numerical character strings; determining an axis scale based on the numerical character strings and the corresponding plurality of plot locations; identifying a datapoint marker comprising datapoint marker pixels; generating at least one mirror image of the datapoint marker, each of the at least one mirror images comprising corresponding mirror image pixels; generating a composite image of the datapoint marker and the at least one mirror image, the composite image comprising the mirror image pixels of each of the at least one mirror images combined with the datapoint marker pixels; determining a pixel centroid for the composite image of the datapoint marker; and assigning a data value to the datapoint marker based on the pixel centroid and the axis scale.

### RELATED APPLICATIONS

The present application claims priority benefit to U.S. Provisional Application Ser. No. 63/476,679, filed Dec. 22, 2022, entitled AUTOMATIC PROCESSING AND EXTRACTING OF GRAPHICAL DATA, which is hereby incorporated by reference in its entirety into the present application as if fully set forth herein.

### STATEMENT REGARDING FEDERALLY SPONSORED RESEARCH OR DEVELOPMENT

This invention was made with government support under Contract Nos. 2019-41480-30294, 2018-41480-28805, 2019-41480-30296, and 2020-41480-32497, awarded by the U.S. Department of Agriculture. The government has certain rights in the invention.

### FIELD OF THE INVENTION

The present disclosure generally relates to computer-implemented methods, systems comprising computer-readable media, and electronic devices for automatic processing and extracting of graphical data. More particularly, the present disclosure generally relates to systems and methods for analyzing data plots, charts and the like to convert data embodied therein into numerical form.

### BACKGROUND

Data embodied graphically are myriad and voluminous. Modern techniques for deriving the underlying or original data from which such graphic depictions are constructed involve heavy manual intervention. While such manual techniques are extremely time consuming, no alternative for accurate extraction has been developed.

This background discussion is intended to provide information related to the present invention which is not necessarily prior art.

### BRIEF SUMMARY

Embodiments of the present technology relate to computer-implemented methods, systems comprising computer-readable media, and electronic devices for extracting numerical data from a graphical representation. The embodiments may include implementing computer vision and feature extraction modules, such as bounding boxes implemented with convolutional neural network modules (CNNs), respectively or together configured to detect and identify chart layouts, axis markers such as tick marks, legend symbols, shapes and datapoint markers, line characteristics, titles and other labels and alphanumeric strings, and other aspects of data plots. Optical character recognition may be used to extract text information. Cropping and upscaling techniques may be used to prepare the identified strings for character recognition.

Datapoint markers in the chart or plot area may be disambiguated and delineated, and cropping and/or upscaling may again be performed, to transform each marker to corresponding datapoint marker pixels. The datapoint marker pixels of each datapoint marker may be mirrored across at least one internal mirroring axis and resulting mirror images may be combined with the original to generate a composite and find a pixel centroid. The pixel centroids may be mapped into chart coordinates or tuple data (e.g., in pairs, such as with Cartesian coordinates) using extracted and identified axis scale(s). Feature and text extraction from all the modules may be combined to generate labeled, numerical data in tabular format representing the data previously embodied in the chart or plot.

These comprise improvement(s) in computer-related technology, allowing accurate and automated graphical data extraction not previously performable by a computer.

More particularly, in a first aspect, a computer-implemented method for extracting numerical data from a graphical representation may be provided. The method includes: automatically detecting and identifying a plurality of numerical character strings, each of the numerical character strings including at least one number; automatically assigning a plot location respectively to each of the numerical character strings; automatically determining an axis scale based on the numerical character strings and the corresponding plurality of plot locations; automatically detecting and identifying a datapoint marker comprising datapoint marker pixels; automatically generating at least one mirror image of the datapoint marker, each of the at least one mirror images comprising corresponding mirror image pixels; automatically generating a composite image of the datapoint marker and the at least one mirror image, the composite image comprising the mirror image pixels of each of the at least one mirror images combined with the datapoint marker pixels; automatically determining a pixel centroid for the composite image of the datapoint marker; and automatically assigning a data value to the datapoint marker based on the pixel centroid and the axis scale. The method may include additional, less, or alternate actions, including those discussed elsewhere herein.

In another aspect, a system for extracting numerical data from a graphical representation may be provided. The system may include one or more processors individually or collectively programmed to perform the following steps: automatically detect and identify a plurality of numerical character strings, each of the numerical character strings including at least one number; automatically assign a plot location respectively to each of the numerical character strings; automatically determine an axis scale based on the numerical character strings and the corresponding plurality of plot locations; automatically detect and identify a datapoint marker comprising datapoint marker pixels; automatically generate at least one mirror image of the datapoint marker, each of the at least one mirror images comprising corresponding mirror image pixels; automatically generate a composite image of the datapoint marker and the at least one mirror image, the composite image comprising the mirror image pixels of each of the at least one mirror images combined with the datapoint marker pixels; automatically determine a pixel centroid for the composite image of the datapoint marker; and automatically assign a data value to the datapoint marker based on the pixel centroid and the axis scale. The system may include additional, less, or alternate functionality, including that discussed elsewhere herein.

In still another aspect, a system comprising computer-readable media having computer-executable instructions stored thereon for extracting numerical data from a graphical representation may be provided. The computer-readable instructions may instruct at least one processor to perform the following steps: automatically detect and identify a plurality of numerical character strings, each of the numerical character strings including at least one number; automatically assign a plot location respectively to each of the numerical character strings; automatically determine an axis scale based on the numerical character strings and the corresponding plurality of plot locations; automatically detect and identify a datapoint marker comprising datapoint marker pixels; automatically generate at least one mirror image of the datapoint marker, each of the at least one mirror images comprising corresponding mirror image pixels; automatically generate a composite image of the datapoint marker and the at least one mirror image, the composite image comprising the mirror image pixels of each of the at least one mirror images combined with the datapoint marker pixels; automatically determine a pixel centroid for the composite image of the datapoint marker; and automatically assign a data value to the datapoint marker based on the pixel centroid and the axis scale. The computer-readable instructions may instruct the processor(s) to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for extracting numerical data from a graphical representation in accordance with embodiments of the present invention;

FIGS. 2 and 3 respectively illustrate various components of an exemplary computing device and server shown in block schematic form that may be used with the system of FIG. 1;

FIG. 4 is a flowchart illustrating exemplary logical components or modules and data flow through steps for extracting numerical data from a graphical representation in accordance with embodiments of the present invention;

FIG. 5 is a flowchart illustrating at least a portion of the steps for a method of extracting numerical data from a graphical representation in accordance with embodiments of the present invention;

FIGS. 6A-6B respectively illustrate exemplary graphical representations or plots with computer vision bounding boxes applied for symbol and/or text extraction of numerical value axis labels;

FIGS. 7A-7B respectively illustrate exemplary graphical representations or plots with computer vision bounding boxes applied for symbol and/or text extraction of chart or plot title and x- and y-axis labels and for chart layout pattern recognition and classification;

FIGS. 8A-8B respectively illustrate exemplary graphical representations or plots with computer vision bounding boxes applied for symbol and/or text extraction of legend data and datapoint markers;

FIG. 9 illustrates a data plot with overlapping datapoint marker symbols; and FIGS. 10A-10B respectively illustrate pixel centroid determination for symbols of various shapes.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for data extraction from graphical representations or plots are slow, largely manual and/or inaccurate. Embodiments of the present invention provide rules, modules and steps for performing automated and accurate extraction that comprise improvement(s) in computer-related technology, allowing accurate and automated graphical data extraction not previously performable by a computer.

### Exemplary System

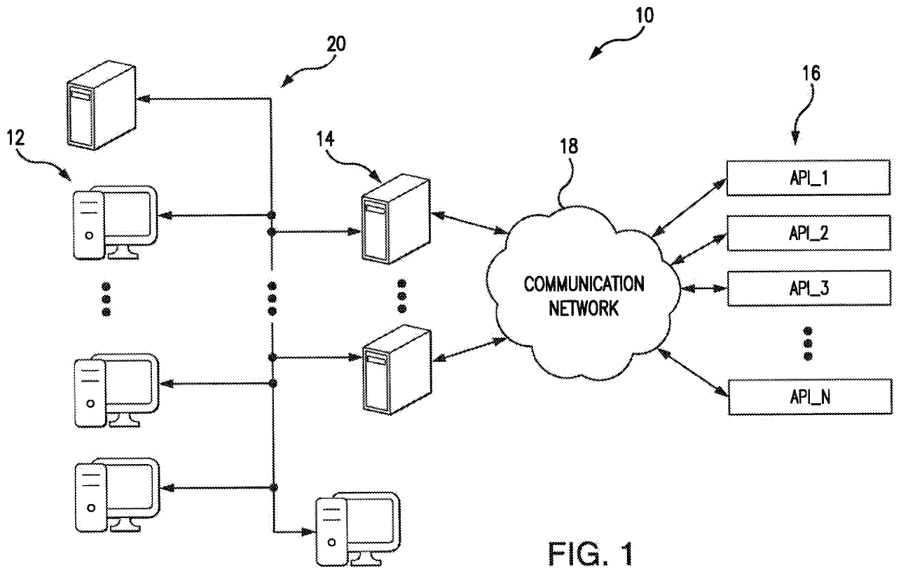

FIG. 1 depicts an exemplary environment 10 for extracting numerical data from a graphical representation according to embodiments of the present invention. The environment 10 may include a plurality of computers 12, a plurality of servers 14, a plurality of application programming interfaces (APIs) 16, and a communication network 18. The computers 12 and the servers 14 may be located within network boundaries of a large organization, such as a corporation, a government office, or the like. The communication network 18 and the APIs 16 may be external to the organization, for example where the APIs 16 are offered by research data providers or related third parties making graphical research data available for analysis. The APIs 16 may comprise, be implemented by and/or be replaced by web servers or the like, it being understood that many sources of graphical data are within the scope of the present invention.

More particularly, the computers 12 and servers 14 may be connected to an internal network 20 of the organization, which may comprise a trusted internal network or the like. Alternatively or in addition, the computers 12 and servers 14 may manage access to the APIs 16 under a common authentication management framework. Each user of a device 12 may be required to complete an authentication process to access data obtained from the APIs 16 via the servers 14. In one or more embodiments, one or more computers 12 may not be internal to the organization, but may be permitted access to perform the queries via the common authentication management framework. For instance, the common authentication management framework may comprise one or more servers made available under WebSEAL® (a registered trademark of International Business Machines Corporation). Moreover, all or some of the APIs 16 may be maintained and/or owned by the organization and/or may be maintained on the internal network 20 within the scope of the present invention. One of ordinary skill will appreciate that the servers 14 may be free of, and/or subject to different protocol(s) of, the common authentication management framework within the scope of the present invention.

Data made available via the APIs 16 may include research data in graphical representation format, such as line and scatter plots and/or bar charts, pie charts, or the like. Further, the servers 14 may be maintained by a data analysis and conversion organization, and an authenticated employee of the foregoing may access an exemplary system implemented on the servers 14 to query the APIs 16 and/or direct conversion of the obtained information and extraction of numerical data therefrom. An employee of the data analysis and conversion organization may also access such an exemplary system from a computer 12 to query the APIs 16 and/or direct conversion of the obtained information and extraction of numerical data therefrom. One of ordinary skill will appreciate that embodiments may serve a wide variety of organizations and/or rely on a wide variety of datasources within the scope of the present invention. For example, one or more datasources accessed by a system according to embodiments of the present invention may be available to the public. Moreover, one of ordinary skill will appreciate that different combinations of one or more computing devices—including a single computing device or server—may implement embodiments without departing from the spirit of the present invention.

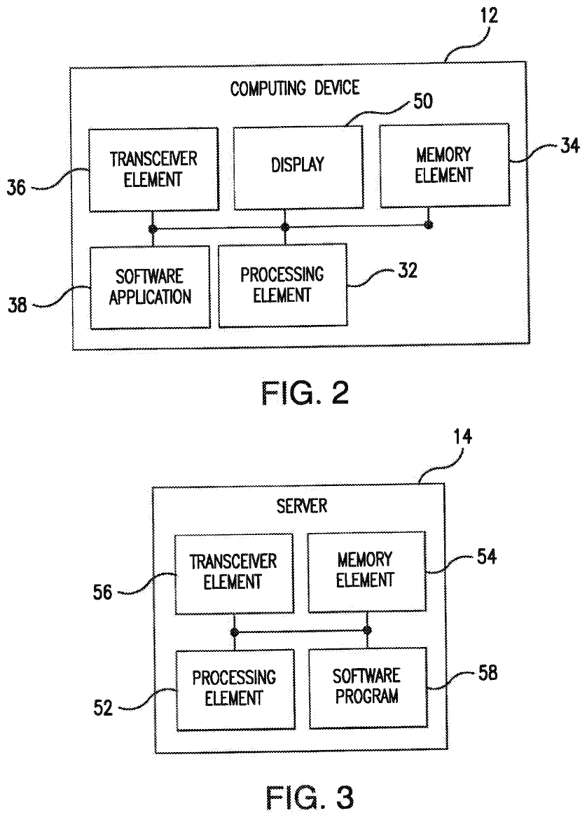

The computers 12 may be workstations. Turning to FIG. 2, generally the computers 12 may include tablet computers, laptop computers, desktop computers, workstation computers, smart phones, smart watches, and the like. In addition, the computers 12 may include copiers, printers, routers and any other device that can connect to the internal network 20 and/or the communication network 18. Each computer 12 may include a processing element 32 and a memory element 34. Each computer 12 may also include circuitry capable of wired and/or wireless communication with the internal network 20 and/or the communication network 18, including, for example, transceiver elements 36. Further, the computers 12 may respectively include a software application 38 configured with instructions for performing and/or enabling performance of at least some of the steps set forth herein. In one or more embodiments, the software applications 38 comprise programs stored on computer-readable media of memory elements 34. Still further, the computers 12 may respectively include a display 50.

Generally, the servers 14 act as a bridge between the computers 12 and/or internal network 20 of the organization on the one hand, and the communication network 18 and APIs 16 of the outside world on the other hand. In one or more embodiments, the servers 14 also provide communication between the computers 12 and internal APIs 16. The servers 14 may include a plurality of proxy servers, web servers, communications servers, routers, load balancers, and/or firewall servers, as are commonly known.

The servers 14 also generally implement a platform for managing receipt and storage of input graphical representations and charts (e.g., from APIs 16) and/or performance of requested data conversion and extraction and/or related tasks outlined herein. The servers 14 may retain electronic data and may respond to requests to retrieve data as well as to store data. The servers 14 may comprise domain controllers, application servers, database servers, file servers, mail servers, catalog servers or the like, or combinations thereof. In one or more embodiments, one or more APIs 16 may be maintained by one or more of the servers 14. Generally, each server 14 may include a processing element 52, a memory element 54, a transceiver element 56, and a software program 58.

Each API 16 may include and/or provide access to one or more pages or sets of data, plots and/or other content accessed through the World Wide Web (e.g., through the communication network 18) and/or through the internal network 20. Each API 16 may be hosted by or stored on a web server and/or database server, for example. The APIs 16 may include top-level domains such as “.com”, “.org”, “.gov”, and so forth. The APIs 16 may be accessed using software such as a web browser, through execution of one or more script(s) for obtaining graphical representations and data, and/or by other means for interacting with APIs 16 without departing from the spirit of the present invention.

The communication network 18 generally allows communication between the servers 14 of the organization and external APIs such as provider APIs 16. The communication network 18 may also generally allow communication between the computers 12 and the servers 14, for example in conjunction with the common authentication framework discussed above and/or secure transmission protocol(s). The internal network 20 may generally allow communication between the computers 12 and the servers 14. The internal network 20 may also generally allow communication between the servers 14 and internal APIs 16.

The networks 18, 20 may include the Internet, cellular communication networks, local area networks, metro area networks, wide area networks, cloud networks, plain old telephone service (POTS) networks, and the like, or combinations thereof. The networks 18, 20 may be wired, wireless, or combinations thereof and may include components such as modems, gateways, switches, routers, hubs, access points, repeaters, towers, and the like. The computers 12, servers 14 and/or APIs 16 may, for example, connect to the networks 18, 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The transceiver elements 36, 56 generally allow communication between the computers 12, the servers 14, the networks 18, 20, and/or the APIs 16. The transceiver elements 36, 56 may include signal or data transmitting and receiving circuits, such as antennas, amplifiers, filters, mixers, oscillators, digital signal processors (DSPs), and the like. The transceiver elements 36, 56 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver elements 36, 56 may utilize communication standards such as ANT, ANT+, Bluetooth™ low energy (BLE), the industrial, scientific, and medical (ISM) band at 2.4 gigahertz (GHz), or the like. Alternatively, or in addition, the transceiver elements 36, 56 may establish communication through connectors or couplers that receive metal conductor wires or cables, like Cat 6 or coax cable, which are compatible with networking technologies such as ethernet. In certain embodiments, the transceiver elements 36, 56 may also couple with optical fiber cables. The transceiver elements 36, 56 may respectively be in communication with the processing elements 32, 52 and/or the memory elements 34, 54.

The memory elements 34, 54 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 34, 54 may be embedded in, or packaged in the same package as, the processing elements 32, 52. The memory elements 34, 54 may include, or may constitute, a “computer-readable medium.” The memory elements 34, 54 may store the instructions, code, code segments, software, firmware, programs, applications, apps, services, daemons, or the like that are executed by the processing elements 32, 52. In one or more embodiments, the memory elements 34, 54 respectively store the software applications/program 38, 58. The memory elements 34, 54 may also store settings, data, documents, sound files, photographs, movies, images, databases, and the like.

The processing elements 32, 52 may include electronic hardware components such as processors. The processing elements 32, 52 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 32, 52 may include digital processing unit(s). The processing elements 32, 52 may generally execute, process, or run instructions, code, code segments, software, firmware, programs, applications, apps, processes, services, daemons, or the like. For instance, the processing elements 32, 52 may respectively execute the software applications/program 38, 58. The processing elements 32, 52 may also include hardware components such as finite-state machines, sequential and combinational logic, and other electronic circuits that can perform the functions necessary for the operation of the current invention. The processing elements 32, 52 may be in communication with the other electronic components through serial or parallel links that include universal busses, address busses, data busses, control lines, and the like.

Returning to FIG. 1, the servers 14 may manage queries to, and responsive graphical representations and data received from, APIs 16, and perform related analytical functions (e.g., as requested by one or more of the computing devices 12) in accordance with the description set forth herein. In one or more embodiments, the graphical representations and data may be acquired by other means, and the steps for analysis and extraction laid out herein may be requested and/or performed by different computing devices (or by a single computing device), without departing from the spirit of the present invention.

The graphical representations and data and numerical and graph metadata extracted therefrom may be stored in databases managed by the servers 14 utilizing any of a variety of formats and structures within the scope of the invention. For instance, relational databases and/or object-oriented databases may embody such databases. Similarly, the APIs 16 and/or databases may utilize a variety of formats and structures within the scope of the invention, such as Simple Object Access Protocol (SOAP), Remote Procedure Call (RPC), and/or Representational State Transfer (REST) types. One of ordinary skill will appreciate that—while examples presented herein may discuss specific types of databases—a wide variety may be used alone or in combination within the scope of the present invention.

Through hardware, software, firmware, or various combinations thereof, the processing elements 32, 52 may—alone or in combination with other processing elements—be configured to perform the operations of embodiments of the present invention.

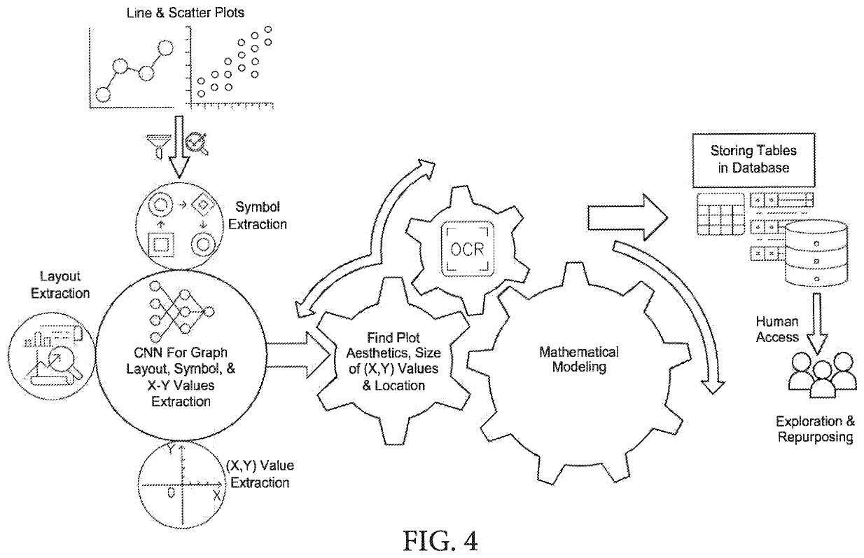

For example, FIG. 4 illustrates a plurality of logical components or modules and a data flow across those components that may be implemented by one or more of the devices 12, 14. More particularly, the illustrated components implement computer vision and feature extraction modules, such as bounding boxes implemented with CNNs, respectively or together configured to detect and identify chart layouts, axis markers such as tick marks, legend symbols, shapes and datapoint markers, line characteristics, titles and other labels and alphanumeric strings, and other aspects of data plots.

In one or more embodiments, the bounding boxes and CNNs are implemented in accordance with known techniques. Namely, convolutional and pooling layers of the CNN are used with a classifier to generate class scores (e.g., Softmax C) and a bounding box regressor for determining loss. The outputs of the classifier and regressor may be combined for each bounding box to determine a score for best prediction. Potential bounding boxes are iteratively drawn until the best score is produced for the shape to be recognized. However, it should be appreciated that a variety of computer vision technologies and techniques, and indeed other techniques for using bounding boxes and/or CNNs, are within the scope of the present invention.

Preferably, the CNNs are capable of understanding and performing relational reasoning on different shapes, colors, and sizes provided in training images. Moreover, the CNN's are preferably capable of automatically detecting axis values and legends. Each CNN model or module may be trained on permutations such as various markers, random size objects, different line styles, colors, fonts, width, and overlapping images, with or without error bars, and the like, enhancing the ability of the module(s) to identify and extract different scatter types from published results (graph images) with high accuracy.

The training data and images may at least in part be generated by randomly varying features of plots within pre-determined rules. The training data and images may be used to train the one or more CNN-based modules to use bounding boxes to identify objects and assign pixel coordinates corresponding to the bounding boxes to those objects, and to label the objects with object classes (e.g., axis labels or tick marks, alphanumeric strings, datapoint markers, legend labels, legend line characteristics, chart or plot titles, axis labels, and the like).

Optical character recognition may be used to extract text information. Cropping and upscaling techniques may be used to prepare the identified strings for character recognition.

Datapoint markers in the chart or plot area may be disambiguated and delineated, and cropping and/or upscaling may again be performed, to transform each marker to corresponding datapoint marker pixels and plot locations. The datapoint marker pixels of each datapoint marker may be mirrored across at least one internal mirroring axis and resulting mirror images may be combined with the original to generate a composite and find a pixel centroid. The pixel centroids may be mapped into chart coordinates or tuple data (e.g., in pairs, such as with Cartesian coordinates) using extracted and identified axis scale features. Feature and text extraction from all the modules may be combined to generate labeled, numerical data in tabular format representing the data previously embodied in the chart or plot.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Computer-Implemented Method for Extracting Numerical Data From a Graphical Representation

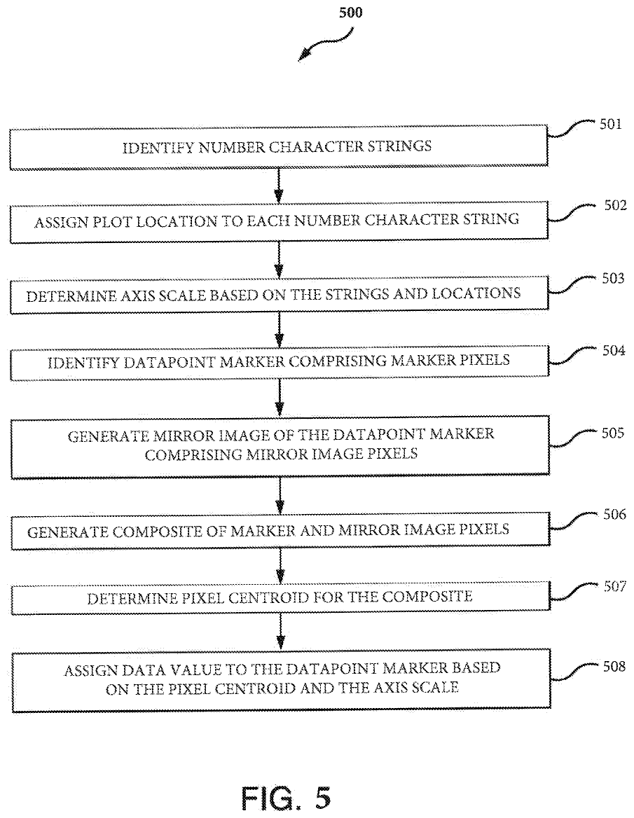

FIG. 5 depicts a flowchart including a listing of steps of an exemplary computer-implemented method 500 for extracting numerical data from a graphical representation. The steps may be performed in the order shown in FIG. 5, or they may be performed in a different order. Furthermore, some steps may be performed concurrently as opposed to sequentially. In addition, some steps may be optional.

The computer-implemented method 500 is described below, for ease of reference, as being executed by exemplary devices and components introduced with the embodiments illustrated in FIGS. 1-4. For example, the steps of the computer-implemented method 100 may be performed by the computer 12, the server 14 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. Moreover, though the present disclosure privileges modular implementation of components of computer vision and extraction, monolithic or otherwise consolidated solutions are also within the scope of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Initially, it should be noted that a graphical data or plot gathering step may precede or otherwise be performed in connection with the steps discussed in more detail below. Such data collection may be performed by and/or at the direction of one or both of a computing device and a server. The data may be obtained periodically, continuously and/or upon request from a variety of sources. For example, an automated data acquisition process may cause intermittent batch downloads of graphical data or plots from APIs associated with data publishers and/or third-party databases storing such data to network servers and/or computing devices.

Referring to step 501, a plurality of numerical character strings may be automatically detected and identified, each of the numerical character strings including at least one number. In one or more embodiments, the numerical character strings are aligned along or adjacent to, and/or otherwise visually identified with, an axis of a data plot. Step 501 may be performed by and/or at the direction of one or both of a computing device and a server.

The detection and identification may be performed by one or more computer vision and feature extraction modules. In one or more embodiments, bounding boxes are implemented with CNNs respectively or together configured to detect and identify the numerical character strings as group(s) comprising one or more numbers.

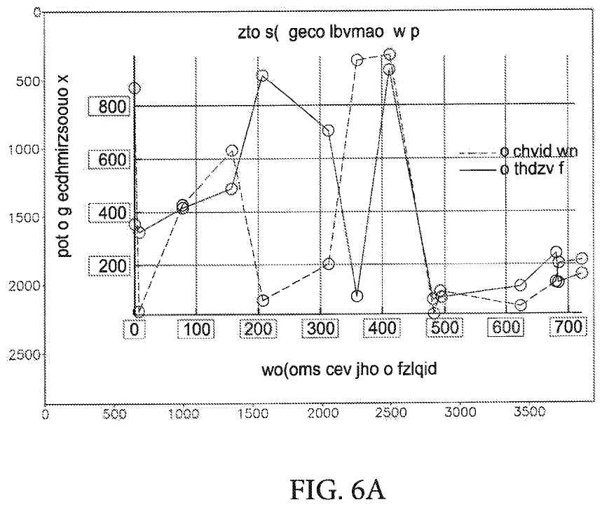

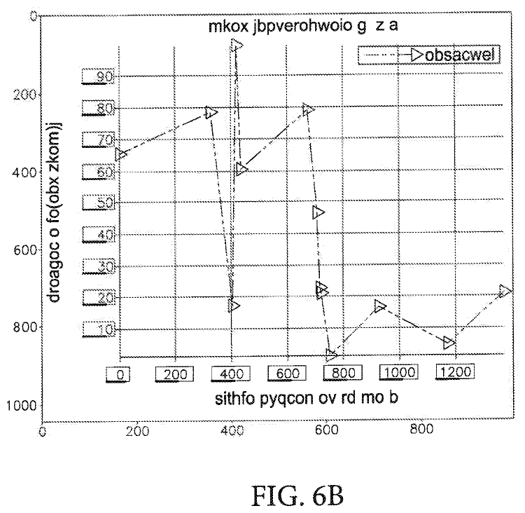

In one or more embodiments, the (X, Y) Value Extraction and CNN for Graph Layout, Symbol, & X-Y Values Extraction modules of FIG. 4 may perform step 501. Turning briefly to FIGS. 6A-B, bounding boxes are shown drawn around numerical axis labels of respective data plots. The numerical character strings extend along an additional axis, substantially perpendicular or orthogonal to the first axis, in the manner of a Cartesian coordinate plane or chart having x- and y-axes. Accordingly, the method may include detecting and identifying the additional axis strings in substantially the same manner as those of the first axis, discussed in more detail above.

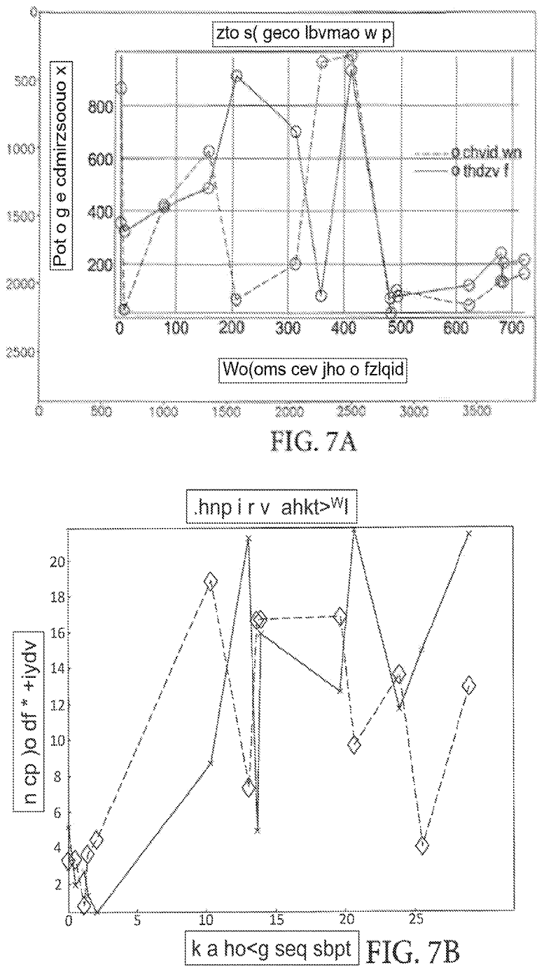

Further, it should be noted that, in one or more embodiments, a chart layout detection and/or classification step may be performed in connection with the method 500. The step may be performed by and/or at the direction of one or both of a computing device and a server. Turning briefly to FIG. 4, the Layout Extraction and CNN for Graph Layout, Symbol, & X-Y Values Extraction modules may perform this step. Turning briefly to FIGS. 7A-7B, bounding boxes are shown drawn around respective chart or plot areas (or scatter or image regions), as well as around chart or plot title and x- and y-axis labels, of respective data plots. The CNN for Graph Layout, Symbol, & X-Y Values Extraction module may additionally extract chart or plot title and x- and y-axis labels. In addition, the CNN for Graph Layout, Symbol, & X-Y Values Extraction module may, based on recognition and/or classification of the chart or plot, determine that the axis or axes comprising the chart or plot are rotated or skewed so as to not be substantially orthogonal and may automatically rotate or otherwise adjust the plot for further processing and data extraction.

The strings, titles and labels may be processed to extract text information and data therefrom. Following detection and identification of such alphanumeric strings using the bounding box and CNN method(s), the pixel maps comprising each string may be cropped to enable clearer recognition. If necessary, the string(s) may additionally be upscaled, again to improve the likelihood of successful character recognition. The resulting image or pixel map may be processed by an optical character recognition (OCR) module (see FIG. 4). For step 501, the result may be one or more sets of two or more numerical values aligned along or otherwise associated with one or more corresponding axes.

The bounding boxes—and, more specifically, their pixel coordinates within the plot or chart—discussed in connection with method 500 may additionally be saved and stored for use in filtering misclassifications after data extraction.

It should additionally be noted that the detection, identification, extraction and recognition steps of the method 500 may be performed in various orders and/or in parallel within the scope of the present invention.

Referring to step 502, a plot location is automatically assigned respectively to each of the plurality of numerical character strings. In one or more embodiments, the numerical character strings are aligned along or adjacent to, and/or otherwise visually identified with, an axis of the data plot. The plot location for each of the numerical character strings may correspond to a visual demarcation along the corresponding axis, such as a tick mark or the like along the axis. Step 502 may be performed by and/or at the direction of one or both of a computing device and a server.

Detection and identification of each plot location may be performed by one or more computer vision and feature extraction modules. In one or more embodiments, bounding boxes are implemented with CNNs respectively or together configured to detect and identify the plot location(s) (e.g., tick marks along respective axes).

In one or more embodiments, the (X, Y) Value Extraction and CNN For Graph Layout, Symbol, & X-Y Values Extraction modules of FIG. 4 may perform plot location detection and identification. The plot locations or tick marks may, again, extend along an additional axis, substantially perpendicular or orthogonal to the first axis, in the manner of a Cartesian coordinate plane or chart having x- and y-axes. Accordingly, the method may include detecting and identifying the additional axis plot locations or tick marks in substantially the same manner as those of the first axis, discussed in detail above.

In one or more embodiments, the CNN For Graph Layout, Symbol, & X-Y Values Extraction is configured to associate, link or assign each plot location (e.g., tick mark) with one (e.g., the closest) of the numerical character strings detected and identified in connection with step 501 above. With brief reference to FIG. 6A, for example, the topmost and bottommost y-axis tick marks—or, more particularly, their plot/pixel locations on the corresponding pixel map illustrated surrounding the chart or image area in FIG. 6A—may be associated respectively with recognized numerical character string values 800 and 200 (or 0, as the case may be). Likewise, the rightmost and leftmost x-axis tick marks (or plot/pixel locations) may be associated respectively with recognized numerical character string values 700 and 100 (or zero, as the case may be). In this manner, the number values along the axes are associated with the pixel plot or chart location to which the other chart components and values are mapped.

Referring to step 503, an axis scale may be automatically determined based on the plurality of numerical character strings and the corresponding plurality of plot locations. Step 503 may be performed by and/or at the direction of one or both of a computing device and a server.

In one or more embodiments, each axis detected and identified in the graphical representation chart or plot is associated with a plurality of numerical character strings and a corresponding plurality of plot locations on the pixel plot. The CNN For Graph Layout, Symbol, & X-Y Values Extraction and/or Mathematical Modeling modules of FIG. 4 may be configured to determine the axis scale—whether linear, quadratic, exponential, logarithmic or otherwise—based on these spatial/numerical pairings, and map the axis scale to the corresponding axes of the coordinate or pixel plot. Accordingly, minimum and maximum values along each axis may be assigned in the pixel plot at the locations of extreme opposite tick marks or similar extrema.

For example, in FIG. 6A, the CNN For Graph Layout, Symbol, & X-Y Values Extraction and/or Mathematical Modeling modules of FIG. 4 may be configured to recognize that the change in pixel location along each axis relative to the change in numerical character string values is linear along both of the x- and y-axes, and may therefore classify the axes as “linear” and map a corresponding axis scale to each axis. Each axis scale may essentially define the starting point on the pixel plot for the axes, and a linear relationship for change in numerical value along each axis per pixel of movement along the axis. One of ordinary skill will appreciate that more complex equations may be developed by the modules to represent quadratic, exponential, logarithmic or other scales.

Referring to step 504, a datapoint marker comprising datapoint marker pixels may be automatically detected and identified. In one or more embodiments, the datapoint marker belongs to a dataset of the data plot, with the dataset being represented by a series of datapoint markers of the same shape and, optionally, connected by a line having consistent format. Step 504 may be performed by and/or at the direction of one or both of a computing device and a server.

The detection and identification of the datapoint marker(s) may be performed by one or more computer vision and feature extraction modules. In one or more embodiments, bounding boxes are implemented with CNNs respectively or together configured to detect and identify the symbols comprising the datapoint markers.

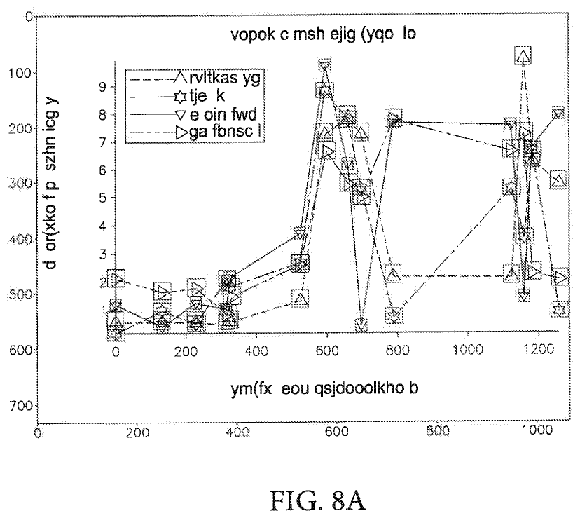

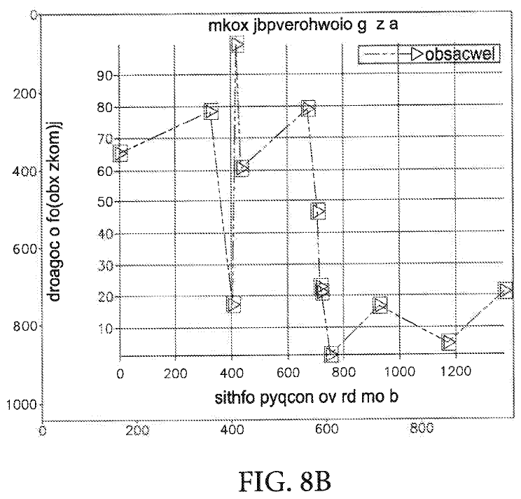

In one or more embodiments, the (X, Y) Value Extraction, Symbol Extraction and/or CNN For Graph Layout, Symbol, & X-Y Values Extraction modules of FIG. 4 may perform step 504. Turning briefly to FIGS. 8A-B, bounding boxes are shown drawn around the datapoint markers and plot legends of respective data plots.

Further, it should be noted that, in one or more embodiments, a legend symbol, line and text extraction step may be performed in connection with the method 500. The step may be performed by and/or at the direction of one or both of a computing device and a server. Turning briefly to FIG. 4, the Symbol Extraction and/or CNN For Graph Layout, Symbol, & X-Y Values Extraction modules of FIG. 4 may perform this step. As noted above with reference to FIGS. 8A-B, bounding boxes are shown drawn around respective dataset line and symbol depictions and accompanying text of respective data plots in connection with the system for detecting and identifying the legend symbols, lines and corresponding text. Exemplary symbol shapes including circle, square, diamond, triangle (e.g., in four different orientations: upward/downward/right/left-pointing triangles), point, asterisk, plus, cross, star, pentagram, hexagram, etc. are also within the scope of the present invention.

The modules may use detection and identification of the symbols and lines described in the plot legend to disambiguate and delineate the datapoint markers in the chart or image area of the data plot, particularly where markers of one or more of the datasets overlap one another and obscure respective outer boundaries. The legend preferably provides a clear reproduction of and template for the expected shape and other characteristics of each datapoint marker symbol for each dataset appearing in the chart or image area of the data plot. The other characteristics of each symbol may include, for example, filled or hollow, color, solid or broken lines, thickness of lines, etc. Accordingly, the modules may be configured to identify a legend symbol shape, and detecting and identifying the datapoint marker pixels may include comparing the legend symbol shape to the datapoint marker to determine an overlapping condition and, based on the legend symbol shape, cropping the datapoint marker.

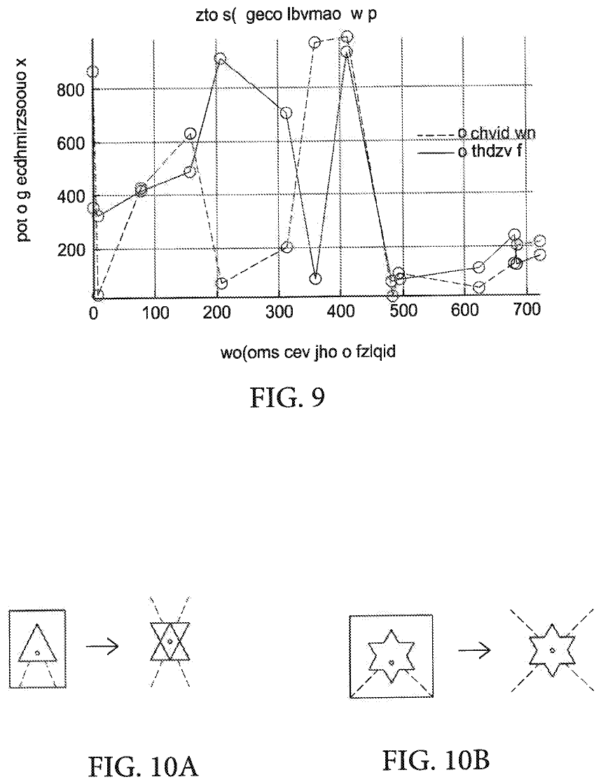

Further, consistent legend line characteristics may also be depicted in the legend, such as color, thickness, dashed or solid and, if dashed, consistent patterns of gap length(s), etc. In one or more embodiments, the modules for detecting and identifying datapoint markers in the chart or image area may detect and identify each line corresponding to a dataset in the chart or image area. The modules may project a path for each identified line through overlapping datapoint markers or otherwise congested graphical areas of the chart or image area. Because each line is associated with a known symbol shape (and other characteristics), the path may be considered by the modules when determining the best bounding box around each datapoint marker, cropping out other datapoint markers or other overlapping image pixels, and the like. For example, if two (2) equally likely interpretations for disambiguating and identifying two (2) different and heavily overlapping symbols are generated, a projected path of a line known to be associated with a first symbol type may essentially bisect that first symbol type in the first interpretation, but may be badly misaligned with the first symbol type under the second interpretation. The projected line path may accordingly be used to select the first interpretation for disambiguating and cropping the two (2) symbols from each other. For example, FIG. 9 illustrates two (2) legend line types (one dashed, the other solid) corresponding to two (2) datasets, but with each having hollow circles for datapoint marker symbols. The projected line path for each of the legend line types may help delineate, disambiguate and crop the datapoint marker circles of the respective datasets. Accordingly, the modules may be configured to identify a legend line characteristic, with detecting and identifying the datapoint marker pixels including determining a line path based on the legend line characteristic and the cropping of the datapoint marker being based in part on the line path.

The identified legend text may be processed to extract text information and data therefrom. Following detection and identification of such legend text using, for example, the bounding box and CNN method(s), the pixel maps comprising each letter may be cropped to enable clearer recognition. If necessary, the letters may additionally be upscaled, again to improve the likelihood of successful character recognition. The resulting image or pixel map may be processed by an optical character recognition (OCR) module (see FIG. 4). For step 504, the result may be one or more sets of descriptive words associated with one or more corresponding datasets.

Referring to step 505, at least one mirror image of the datapoint marker may be automatically generated. Each mirror image may be generated by folding the original image of the datapoint marker over an internal axis of the original image to generate the mirrored image of the original on the other side of the axis. Step 505 may be performed by and/or at the direction of one or both of a computing device and a server. Turning briefly to FIG. 4, the Symbol Extraction, CNN For Graph Layout, Symbol, & X-Y Values Extraction and/or Find Plot Aesthetics, Size of (X, Y) Values & Location modules of FIG. 4 may perform this step.

Referring to step 506, a composite image of the datapoint marker may be automatically generated. The composite image may comprise the mirror image pixels of each of the at least one mirror images combined with the datapoint marker pixels. Step 506 may be performed by and/or at the direction of one or both of a computing device and a server. Turning briefly to FIG. 4, the Symbol Extraction, CNN For Graph Layout, Symbol, & X-Y Values Extraction and/or Find Plot Aesthetics, Size of (X, Y) Values & Location modules of FIG. 4 may perform this step.

Turning now to FIG. 10A, an original image of an upward-pointing triangle-shaped datapoint marker is illustrated on the left, inside its corresponding bounding box used for detection and identification (as discussed in more detail above). A composite image comprising the pixels of the original image combined with those of its mirror image is illustrated on the right. A different, star-shaped symbol is illustrated in FIG. 10B, with the original image in its corresponding bounding box illustrated on the left, and an upscaled version of the original image illustrated on the right.

Referring to step 507, a pixel centroid for the composite image of the datapoint marker may be automatically determined. Step 507 may be performed by and/or at the direction of one or both of a computing device and a server. Turning briefly to FIG. 4, the Symbol Extraction, CNN For Graph Layout, Symbol, & X-Y Values Extraction, Find Plot Aesthetics, Size of (X, Y) Values & Location, and/or Mathematical Modeling modules of FIG. 4 may perform this step.

Turning now to FIGS. 10A-10B, initial centers in the respective leftmost images are shown corrected to pixel centroids in the respective rightmost images. In one or more embodiments, each pixel centroid is essentially determined as the geometric center of mass (optionally taking into account intensity) of the composite image of the datapoint marker.

Further, embodiments of the present invention may additionally introduce an offset from the pixel centroid for each datapoint marker symbol type. For example, where it is known that an application originally producing the graphical representation chart or plot does so by drawing the symbol upward and rightward from a starting point corresponding to the actual data value, the modules for generating the pixel centroid may measure the offset between the “starting point” and the pixel centroid determined according to step 507, and may be configured to apply the offset to adjust the centroid for step 508 below for each symbol of the corresponding type. It should be noted that an offset may extend in any direction or to any degree (but preferably not beyond the boundaries of the shape of the marker) within the scope of the present invention.

In one or more embodiments, centroid determination based on the composite image may be made using the computer vision library function cv2.moments( ), offered under the OPENCV™ mark by the Open Source Vision Foundation at the time of the initial filing of the present disclosure. Corresponding calculations may be performed according to the disclosure of U.S. Provisional Application Ser. No. 63/476,679, filed Dec. 22, 2022, entitled AUTOMATIC PROCESSING AND EXTRACTING OF GRAPHICAL DATA, which is incorporated by reference in its entirety into the present application.

Referring to step 508, a data value may be automatically assigned to the datapoint marker based on the pixel centroid and the axis scale. In one or more embodiments, the pixel centroid (as calculated by mirror imaging and/or adjusted according to an offset described above) represents the true localized position of the datapoint marker on the chart image or area and, accordingly, on the pixel plot. Because each pixel centroid has a corresponding position on the pixel plot, one or both of the x- and y-axis positional components of the pixel centroid on the pixel plot may be converted to true numerical data values using the corresponding axis scale(s) computed as discussed in more detail above.

It should be noted that assigning true numerical data values to the datapoint marker(s) may, within the scope of the present invention, be made according to the corresponding calculations described in the “Graph Information Extraction” section or otherwise within the disclosure of U.S. Provisional Application Ser. No. 63/476,679, filed Dec. 22, 2022, entitled AUTOMATIC PROCESSING AND EXTRACTING OF GRAPHICAL DATA, which is incorporated by reference in its entirety into the present application.

It should be noted that the steps of the method 500 discussed above may be used repeatedly to determine true numerical data values for each datapoint marker across multiple (e.g., two (2)) axes and across multiple datasets and symbol types of the data plot. In one or more embodiments, the modules are additionally configured to output a structured and labeled data table or file containing the derived numerical data values for the datasets and stored in a database. For example, one output type might comprise a table-like structure containing (x, y) coordinates of graph image datapoint markers together with title and legend information.

Moreover, axis labels or tick marks, alphanumeric strings, datapoint markers, legend labels, legend line characteristics, chart titles, axis labels, and the like may be together used to generate an annotated version of the original chart to include the numerical data values derived from the steps of the method 500.

The method may include additional, less, or alternate steps and/or device(s), including those discussed elsewhere herein.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for extracting numerical data from a graphical representation comprising, via one or more transceivers and/or processors:
automatically detecting and identifying a plurality of numerical character strings, each of the plurality of numerical character strings including at least one number;
automatically assigning a plot location respectively to each of the plurality of numerical character strings;
automatically determining an axis scale based on the plurality of numerical character strings and the corresponding plurality of plot locations;
automatically detecting and identifying a datapoint marker comprising datapoint marker pixels;
automatically generating at least one mirror image of the datapoint marker, each of the at least one mirror images comprising corresponding mirror image pixels;
automatically generating a composite image of the datapoint marker and the at least one mirror image, the composite image comprising the mirror image pixels of each of the at least one mirror images combined with the datapoint marker pixels;
automatically determining a pixel centroid for the composite image of the datapoint marker; and
automatically assigning a data value to the datapoint marker based on the pixel centroid and the axis scale.

2. The computer-implemented method of claim 1, wherein the plurality of numerical character strings and the axis scale extend along a first axis, further comprising, via the one or more processors and/or transceivers—
automatically detecting and identifying a second plurality of numerical character strings, each of the second plurality of numerical character strings including at least one number;
automatically assigning a plot location respectively to each of the second plurality of numerical character strings;
automatically determining a second axis scale based on the second plurality of numerical character strings and the corresponding second plurality of plot locations, the second plurality of numerical character strings and the second axis scale extending along a second axis;
automatically assigning a second data value to the datapoint marker based on the pixel centroid and the second axis scale, the data value and the second data value together comprising a data tuple describing a location on a Cartesian plane.

3. The computer-implemented method of claim 1, further comprising, via the one or more processors and/or transceivers, automatically detecting and identifying one or more plot labels corresponding to one or more of: legend labels, axis labels, and plot titles.

4. The computer-implemented method of claim 3, further comprising, via the one or more processors and/or transceivers, automatically detecting and identifying a plurality of tick marks along the first axis, the plurality of plot locations respectively assigned to the plurality of numerical character strings corresponding to the plurality of tick marks.

5. The computer-implemented method of claim 4, wherein the automatic detection and identification includes using a convolutional neural network (CNN) comprising an artificial neural network trained to extract symbols from graphs, and wherein the CNN generates a bounding box respectively encompassing each of the plurality of numerical character strings, the plurality of tick marks, the datapoint marker and the one or more plot labels.

6. The computer-implemented method of claim 1, further comprising, via the one or more processors and/or transceivers, automatically detecting and identifying a legend symbol shape, and wherein automatically detecting and identifying the datapoint marker pixels includes comparing the legend symbol shape to the datapoint marker to determine an overlapping condition and, based on the legend symbol shape, cropping the datapoint marker.

7. The computer-implemented method of claim 6, further comprising, via the one or more processors and/or transceivers, automatically detecting and identifying a legend line characteristic, and wherein automatically detecting and identifying the datapoint marker pixels includes determining a line path based on the legend line characteristic, the cropping of the datapoint marker being based in part on the line path.

8. A system for extracting numerical data from a graphical representation, the system comprising one or more processors individually or collectively programmed to:
automatically detect and identify a plurality of numerical character strings, each of the plurality of numerical character strings including at least one number;
automatically assign a plot location respectively to each of the plurality of numerical character strings;
automatically determine an axis scale based on the plurality of numerical character strings and the corresponding plurality of plot locations;
automatically detect and identify a datapoint marker comprising datapoint marker pixels;
automatically generate at least one mirror image of the datapoint marker, each of the at least one mirror images comprising corresponding mirror image pixels;
automatically generate a composite image of the datapoint marker and the at least one mirror image, the composite image comprising the mirror image pixels of each of the at least one mirror images combined with the datapoint marker pixels;
automatically determine a pixel centroid for the composite image of the datapoint marker; and
automatically assign a data value to the datapoint marker based on the pixel centroid and the axis scale.

9. The system of claim 8, wherein the plurality of numerical character strings and the axis scale extend along a first axis and the one or more processors are further configured to individually or collectively—
automatically detect and identify a second plurality of numerical character strings, each of the second plurality of numerical character strings including at least one number;
automatically assign a plot location respectively to each of the second plurality of numerical character strings;
automatically determine a second axis scale based on the second plurality of numerical character strings and the corresponding second plurality of plot locations, the second plurality of numerical character strings and the second axis scale extending along a second axis;
automatically assign a second data value to the datapoint marker based on the pixel centroid and the second axis scale, the data value and the second data value together comprising a data tuple describing a location on a Cartesian plane.

10. The system of claim 8, wherein the one or more processors are further configured to individually or collectively automatically detect and identify one or more plot labels corresponding to one or more of: legend labels, axis labels, and plot titles.

11. The system of claim 10, wherein the one or more processors are further configured to individually or collectively automatically detect and identify a plurality of tick marks along the first axis, the plurality of plot locations respectively assigned to the plurality of numerical character strings corresponding to the plurality of tick marks.

12. The system of claim 11, wherein the automatic detection and identification includes using a convolutional neural network (CNN) comprising an artificial neural network trained to extract symbols from graphs, and wherein the CNN generates a bounding box respectively encompassing each of the plurality of numerical character strings, the plurality of tick marks, the datapoint marker and the one or more plot labels.

13. The system of claim 8, wherein the one or more processors are further configured to individually or collectively automatically detect and identify a legend symbol shape, and wherein automatically detecting and identifying the datapoint marker pixels includes comparing the legend symbol shape to the datapoint marker to determine an overlapping condition and, based on the legend symbol shape, cropping the datapoint marker.

14. The system of claim 13, wherein the one or more processors are further configured to individually or collectively automatically detect and identify a legend line characteristic, and wherein automatically detecting and identifying the datapoint marker pixels includes determining a line path based on the legend line characteristic, the cropping of the datapoint marker being based in part on the line path.

15. A non-transitory computer-readable storage media having computer-executable instructions for extracting numerical data from a graphical representation stored thereon, wherein when executed by at least one processor the computer-executable instructions cause the at least one processor to:
automatically detect and identify a plurality of numerical character strings, each of the plurality of numerical character strings including at least one number;
automatically assign a plot location respectively to each of the plurality of numerical character strings;
automatically determine an axis scale based on the plurality of numerical character strings and the corresponding plurality of plot locations;
automatically detect and identify a datapoint marker comprising datapoint marker pixels;
automatically generate at least one mirror image of the datapoint marker, each of the at least one mirror images comprising corresponding mirror image pixels;
automatically generate a composite image of the datapoint marker and the at least one mirror image, the composite image comprising the mirror image pixels of each of the at least one mirror images combined with the datapoint marker pixels;
automatically determine a pixel centroid for the composite image of the datapoint marker; and
automatically assign a data value to the datapoint marker based on the pixel centroid and the axis scale.

16. The computer-readable storage media of claim 15, wherein the plurality of numerical character strings and the axis scale extend along a first axis and the computer-readable instructions are further configured to cause the at least one processor to—
automatically detect and identify a second plurality of numerical character strings, each of the second plurality of numerical character strings including at least one number;
automatically assign a plot location respectively to each of the second plurality of numerical character strings;
automatically determine a second axis scale based on the second plurality of numerical character strings and the corresponding second plurality of plot locations, the second plurality of numerical character strings and the second axis scale extending along a second axis;
automatically assign a second data value to the datapoint marker based on the pixel centroid and the second axis scale, the data value and the second data value together comprising a data tuple describing a location on a Cartesian plane.

17. The computer-readable storage media of claim 15, wherein the computer-readable instructions are further configured to cause the at least one processor to automatically detect and identify one or more plot labels corresponding to one or more of: legend labels, axis labels, and plot titles.

18. The computer-readable storage media of claim 17, wherein the computer-readable instructions are further configured to cause the at least one processor to automatically detect and identify a plurality of tick marks along the first axis, the plurality of plot locations respectively assigned to the plurality of numerical character strings corresponding to the plurality of tick marks.

19. The computer-readable storage media of claim 15, wherein the computer-readable instructions are further configured to cause the at least one processor to automatically detect and identify a legend symbol shape, and wherein automatically detecting and identifying the datapoint marker pixels includes comparing the legend symbol shape to the datapoint marker to determine an overlapping condition and, based on the legend symbol shape, cropping the datapoint marker.

20. The computer-readable storage media of claim 19, wherein the computer-readable instructions are further configured to cause the at least one processor to automatically detect and identify a legend line characteristic, and wherein automatically detecting and identifying the datapoint marker pixels includes determining a line path based on the legend line characteristic, the cropping of the datapoint marker being based in part on the line path.
